(19) United States
(12) Patent Application Publication
(10) Pub. No.: US 2006/0033306 A1
(43) Pub. Date: Feb. 16, 2006

(54) Multi-bar linkage suspension system

(76) Inventor: Steve E. Sanchez, San Jose, CA (US)

Correspondence Address: STETINA BRUNDA GARRED & BRUCKER, 75 ENTERPRISE, SUITE 250, ALISO VIEJO, CA, 92656, US

(21) Appl. No.: 10/916,065

(22) Filed: Aug. 11, 2004

(51) Int. Cl. B62K 9/00

(52) U.S. Cl. 280/283

(57) ABSTRACT

A suspension system attachable to a frame of a vehicle for absorbing shocks caused by bumps along a vehicle travel path is provided. The suspension system may comprise a lower arm, upper arm and toggle link which are connected to respective first and second toggle link pivot points and first and second frame pivot points. The toggle link may further define a wheel axis which is interposed between a toggle link line and an output. In this regard, the wheel axis may traverse along a wheel axis travel path having a constant radius about the output center as the lower arm, upper arm and toggle link cooperatively rotate about respective pivot points in response to bumps along a vehicle travel path.

### CROSS-REFERENCE TO RELATED APPLICATIONS

Not Applicable

### STATEMENT RE: FEDERALLY SPONSORED RESEARCH/DEVELOPMENT

Not Applicable

### BACKGROUND OF THE INVENTION

The present invention relates generally to a suspension system of a vehicle, and more particularly to a multi-bar linkage suspension system with a wheel axis interposed between a toggle link line and an output center for providing a wheel axis travel path with a constant radius about the output center as the multi-bar linkage suspension system cooperatively rotates about a vehicle frame.

Traditionally, bicycles have not incorporated a rear suspension system to absorb shocks caused by bumps or irregularities along a bicycle travel path. In this regard, the shocks caused by the bumps or irregularities are absorbed by a rider's legs and arms and may be considerably uncomfortable for the rider yielding a dangers ride over rugged terrain.

Modernly, bicycles in the marketplace have incorporated rear suspension systems to provide a smoother ride to the rider even in bumpy or irregular terrain. For example, a prior art rear suspension system may have a first arm rotateably connected to a frame of the bicycle and a second arm rotateably connected to the frame of the bicycle. The first and second arms may additionally be rotateably connected to a third arm with the first through third arms forming a trapezoidal configuration capable of rotating about the bicycle frame. Further, the upper arm may be mechanically attached to a shock-absorbing element to absorb any shocks transmitted through the first through third arms. In use, the rider may traverse a terrain with rocks. As the rider traverses over the rocks, the rocks may push the rear wheel attached to the rear suspension system upwardly. This upward movement of the rear wheel causes the first through third arms to rotate about the frame and transmit the shock force from the traversed rock into the shock absorbing element and reducing the shock force absorbed by the rider's legs and arms. However, these prior art rear suspension systems must also incorporate a chain tensioner and a chain guide to maintain constant engagement of a chain to a pedal sprocket and rear wheel sprocket during the rotational movement of the first through third arms about the bicycle frame in response to traversing over rocks and other irregularities along the bicycle travel path.

Accordingly, there is a need to provide for an improved suspension system, which does not require a chain tensioner and/or a chain guide.

### BRIEF SUMMARY OF THE INVENTION

In an embodiment of the present invention, a suspension system of a vehicle is provided which may be attached to a vehicle frame for absorbing shocks caused by bumps along a vehicle travel path. The vehicle may have a wheel, which defines a wheel rotation center and a power transmission system defining an output and its output center. Further, the vehicle frame may define first and second vehicle frame pivot points.

The system may comprise a lower arm, an upper arm, a toggle link and a shock-absorbing element. The lower arm may be rotateably connected to the vehicle frame at the first vehicle frame pivot point. The upper arm may be rotateably connected to the vehicle frame at the second vehicle frame pivot point. The toggle link may include a first toggle link pivot point, second toggle link pivot point and a wheel axis. The lower arm may be rotateably connected to the toggle link at the first toggle link pivot point, and the upper arm may be rotateably connected to the toggle link at the second toggle link pivot point. The first and second toggle link pivot points may define a toggle link line. The wheel axis may be aligned with the wheel rotation center, and the wheel may be rotateably connected to the toggle link.

Further, the wheel axis may be formed on the toggle link so as to be interposed between the toggle link line and the output center for rotating the wheel axis about the output center at a constant radius as the lower arm, upper arm and toggle link cooperatively rotate about respective pivot points in response to the bumps along the vehicle travel path. Additionally, the first and second frame pivot points may define a frame line, and the frame line may be interposed between the output and the wheel axis. Lastly, the shock-absorbing element may be attached to the upper arm and the vehicle.

Moreover, a frame length to toggle link length ratio may be greater than 1 with the first and second frame pivot points defining the frame length, and the first and second toggle link pivot points defining the toggle link length. Further, the frame length may be between about 2.67 inches and about 33 inches, and the toggle link length is between about 1 inch and about 27 inches. Also, the distance between the frame and toggle link first pivot points may be between about 4.17 inches and about 45 inches, and the distance between the frame and toggle link second pivot points may be between about 4.17 inches and about 45 inches.

Additionally, a second leg length to first leg length ratio may be between about 1.2 to about 3.7 with the first toggle link pivot point and wheel axis defining the first leg length, and the second toggle link pivot point and the wheel axis defining the second leg length.

In another aspect of the present invention, a vehicle is provided which incorporates the suspension system. The vehicle may comprise a power transmission system having an output defining an output center, a wheel defining a wheel center, a frame defining first and second frame pivot points and a suspension system.

The suspension system may absorb shocks caused by bumps along a vehicle travel path via a lower arm, upper arm, a toggle link and a shock-absorbing element. The lower arm may be rotateably connected to the vehicle frame at the first frame pivot point. The upper arm may be rotateably connected to the vehicle frame at the second frame pivot point. The toggle link may include a first toggle link pivot point, second toggle link pivot point and a wheel axis. The lower arm may be rotateably connected to the toggle link at the first toggle link pivot point. The upper arm may be rotateably connected to the toggle link at the second toggle link pivot point. Also, the first and second toggle link pivot points may define a toggle link line. The wheel may be rotateably connected to the toggle link with the wheel rotation center aligned to the wheel axis.

The wheel axis may be interposed between the toggle link line and the output center for rotating the wheel axis about the output center at a constant radius as the lower arm, upper arm and toggle link cooperatively rotate about respective pivot points in response to bumps along the vehicle travel path. Additionally, the first and second frame pivot points may define a frame line, and the frame line may be interposed between the output and the wheel axis. Lastly, a shock-absorbing element may be attached to the upper arm and the vehicle frame.

In another aspect of the present invention, a method of fabricating a suspension system of a vehicle attachable to a vehicle frame which absorbs shocks caused by bumps along a vehicle travel path is provided. The vehicle may have a wheel defining a wheel rotation center, a power transmission system defining an output and its output center. Also, the vehicle frame may define first and second frame pivot points.

The method may comprise the steps of designing the suspension system and fabricating the suspension system in accordance with the designed suspension system. The designing step may include the steps of sizing an upper arm, lower arm and toggle link to the vehicle, connecting the lower and upper arms to the toggle link at first and second toggle link pivot points, respectively, connecting the lower and upper arms to the vehicle frame at the first and second frame pivot points, and defining a wheel axis between a toggle link line and the output. The wheel axis being alignable with the wheel rotation center.

Further, the designing step may further comprise the steps of rotating the lower arm, upper arm and toggle link about respective pivot points, tracing a travel path of the wheel axis about the output as the upper arm, lower arm and toggle link cooperatively rotate about respective pivot points based on at least three points along the wheel axis travel path, calculating a travel path axis based on the traced travel path, and redefining the wheel axis relative to the first and second toggle link pivot points until the travel path axis is aligned to the output center.

More particularly, the calculating steps may include the step of determining the travel path axis based on multiple points (i.e., two or more points) along the traced travel path. Also, the connecting steps may include the step of inputting the sized upper arm, lower arm and toggle link into a computer aided engineering program to assist in simulating rotational movement of the upper arm, lower arm and toggle link about respective pivot points.

### BRIEF DESCRIPTION OF THE DRAWINGS

An illustrative and presently preferred embodiment of the invention is shown in the accompanying drawings in which:

FIG. 1 is a side elevation view of a bicycle incorporating the multi-bar linkage suspension system of the present invention with a wheel axis interposed between a toggle link line and an output center;

FIG. 2 is a cross-sectional view of the multi-bar linkage suspension system shown in FIG. 1 in a pre-impact position illustrating the distance (i.e., wheel axis travel path radius) between the wheel axis and the output center as “X”;

FIG. 3 is a cross-sectional view of the multi-bar linkage suspension system shown in FIG. 1 illustrating that the wheel axis travel path radius is maintained at a distance “X” in a post-impact position;

FIG. 4 is a cross-sectional view of the multi-bar linkage suspension system shown in FIG. 1 illustrating that the wheel axis travel path radius is maintained at “X” at the fully extended post impact position;

FIG. 5 is a schematic diagram of the multi-bar linkage suspension system illustrating a wheel axis travel path with a constant radius about the output center from the pre-impact position to the fully extended post-impact position;

FIG. 6 is a top view of a power transmission system operative to transmit power from an output to a wheel input via a series of shafts;

FIG. 7 is a side view of a motorcycle with a frame link incorporating the multi-bar linkage suspension system; and

FIG. 8 is a flow chart of a method of fabricating the multi-link suspension system.

### DETAILED DESCRIPTION OF THE INVENTION

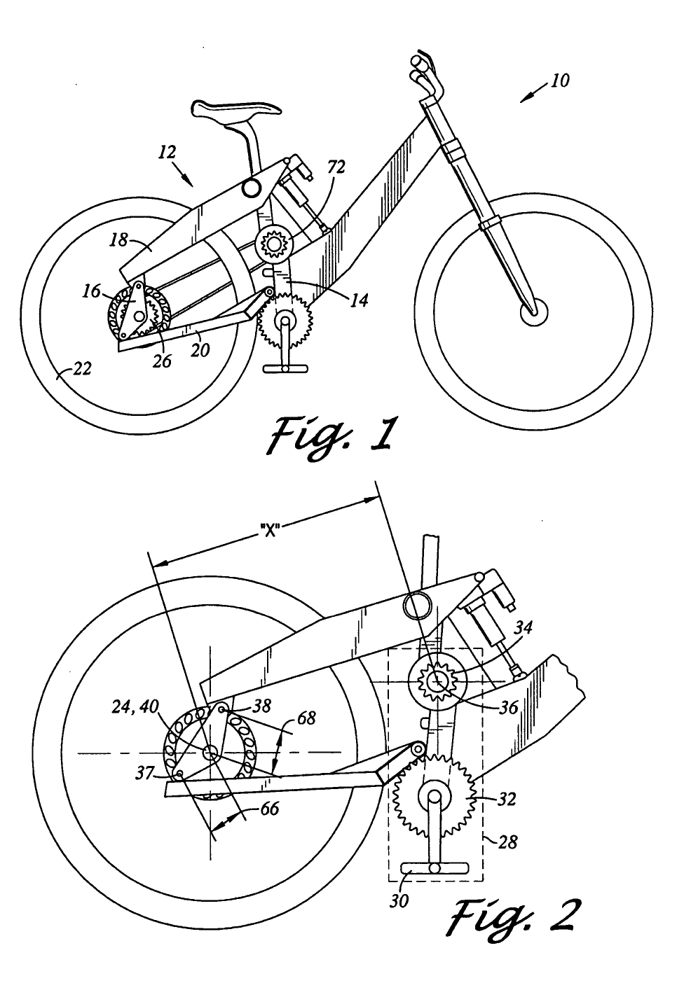

Referring now to the drawings wherein the showings are for the purposes of illustrating the preferred embodiments of the present invention only, and not for the purposes of limiting the same, FIG. 1 illustrates a bicycle 10 incorporating a four bar linkage suspension system 12. In this regard, the present invention is not limited to a suspension system 12 having four bars 14, 16, 18, 20, rather the various aspects of the present invention may be incorporated into a three bar linkage suspension system.

In FIG. 1, the bicycle 10 (i.e., vehicle) may have a wheel 22. The wheel 22 may define a wheel rotation center 24 (see FIG. 2) about which the wheel 22 rotates. Furthermore, the wheel 22 may have a wheel input 26. The wheel input 26 may be any type of mechanism to transmit power to the wheel 22 to rotate the same 22. For example, in FIG. 1, the wheel input is shown as a sprocket. However, it is contemplated within the scope of the present invention that any type of wheel input 26 may be incorporated into the wheel 22 such as a gear or shaft.

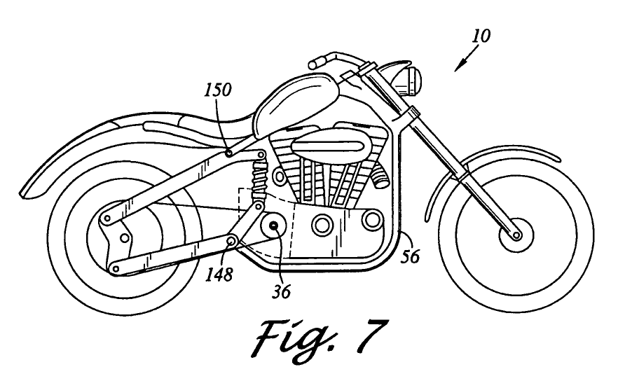

The bicycle 10 (i.e., vehicle) may further have a power transmission system 28, as identified in FIG. 2. In FIG. 2, the power transmission system includes a pedal 30, pedal sprocket 32, output 34 and output center 36. The pedal sprocket 32 transmits power to an output 34 (i.e., transmission cog). Accordingly, the power to the vehicle 10 may be provided by human power. Or, in the alternative, the power to the vehicle 10 may be provided by mechanical power such as through an engine (see FIG. 7). Despite the type of power generation, the output 34 of the power transmission system 28 may have provided power to the wheel 22 via the wheel input 26.

The four bar linkage suspension system shown in FIG. 1 may include the frame link 14 (optional), toggle link 16, upper arm 18 and lower arm 20 which are respectively connected and rotateable to each other. Further, the toggle link 16, upper arm 18 and lower arm 20 shown in FIG. 1 illustrate components for a left side of the bicycle 10; however, the right side of the bicycle 10 may have corresponding mirror imaged component parts which perform identically the same function with respect to the left side component parts of the bicycle, as will be discussed in this detailed description of the present invention. More particularly, the four bar linkage system 12 may have a single frame link 14. The frame link 14 may be connected to the upper arm 18, which may have a fork configuration (not shown) with the wheel 22 interposed between tines (i.e., left side and right side) of the fork configured upper arm 18. The tines may be the upper arm 18 on the left and right sides of the bicycle 10. The frame link 14 may further be connected to the lower arm 20 which may also have a fork configuration with the wheel 22 interposed between the tines of the fork configured lower arm 20. The left side tines of the upper and lower arms 18, 20 may be connected to a left side toggle link 16, and the right side tines of the upper and lower arms 18, 20 may be connected to a right side toggle link 16. Accordingly, although reference throughout this detailed description is made only to the left side components of the suspension system 12, it is understood that there may be corresponding right side component parts. Furthermore, the various aspects of the present invention may be employed with only the component parts for the right or left side of the bicycle 10.

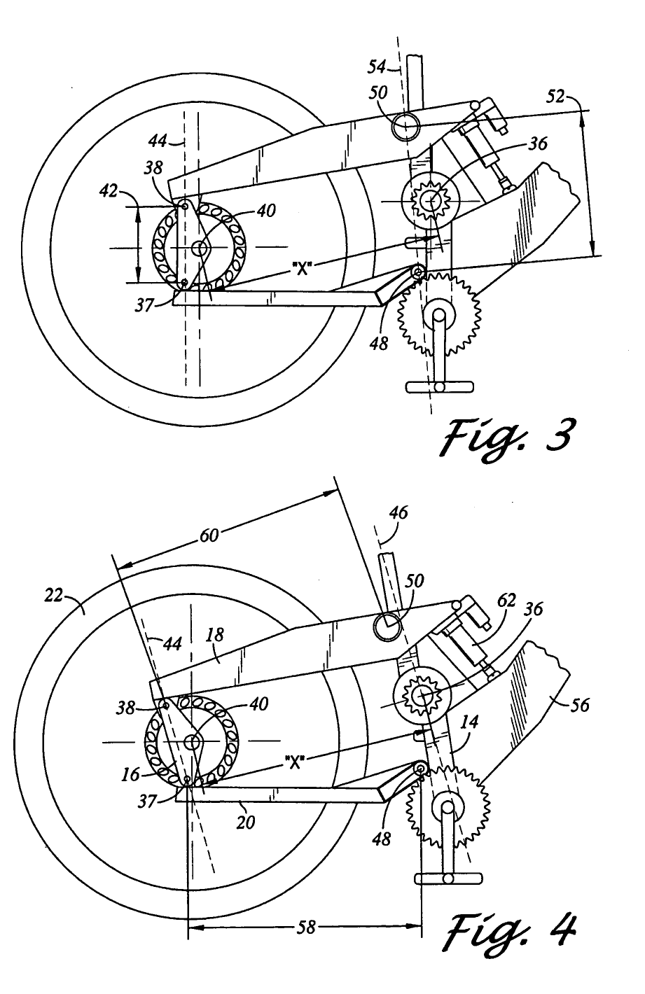

Referring now to FIG. 3, the toggle link 16 may define a first toggle link pivot point 37, second toggle link pivot point 38 and a wheel axis 40. The first and second toggle link pivot points 37, 38 may define a toggle link length 42 therebetween and a toggle link line 44 therethrough. In other words, the toggle link length 42 may be a linear distance between the first and second toggle link pivot points 37, 38, and the toggle link line 44 may be a linear line extending through the first and second toggle link pivot points 37, 38. The wheel axis 40 may be defined by the toggle link 16 and formed on the toggle link 16 so as to be offset from the toggle link line 44, and more particularly, interposed between the toggle link line and the output center 36 (see FIG. 3) when the frame link 14, toggle link 16, upper arm 18 and lower arm 20 are respectively connected and rotateable to each other. More particular, as shown in FIG. 4, a reference line 46 drawn through the output center 36 which is parallel to the toggle link line 44, and in this regard, the wheel axis 40 may be interposed between the toggle link line 44 and the reference line 46. Further, although the toggle link 16 is shown as having a triangular configuration, other configurations are contemplated within the scope of the present invention.

The frame link 14 may define first and second frame link pivot points 48, 50 (see FIG. 3) which define a frame link length 52 therebetween and a frame link line 54 extending therethrough. In other words, the frame link length 52 may be a linear distance between the first and second frame link pivot points 48, 50, and the frame link line 54 may be a linear line extending through the first and second frame line pivot points 48, 50. Further, the first and second frame link pivot points 48, 50 may have a fixed relationship to the output center 36. In other words when the toggle link 16, upper arm 18, and lower arm 20 are respectively connected and rotatable to each other, the first and second frame link pivot points 48, 50 and output center 36 maintain their spatial relationship with respect to its inertial frame. This may be accomplished by fixedly attaching the frame link 14 to the vehicle frame 56. In the alternative, it is further contemplated within the scope of the present invention that the various aspects of the present invention may be embodied and employed without the frame link 14, as shown in FIG. 7. In this regard, the frame 56 of the vehicle 10 may define first and second frame pivot points 148, 150 which have the same spatial relationship to the output center 136 compared to the first and second frame link pivot points 48, 50.

Referring now to FIG. 4, the lower arm 20 may be rotateably connected to frame link 14 at the first frame link and toggle link pivot points 48, 37. In this regard, the distance between the first frame link and toggle link pivot points 48, 37 defines a lower arm length 58. Moreover, the upper arm 18 may be rotateably connected to the second frame link and toggle link pivot points 50, 38. In this regard, the distance between the second frame link and toggle link pivot points 50, 38 defines an upper arm length 60. Further, as stated above, the frame link 14 may be eliminated and incorporated into the frame 56 of the bicycle 10. This may be accomplished by providing for the first and second frame pivot points on the frame 56 of the bicycle 10 itself as long as the first and second frame pivot points 148, 150 remain fixed in relation to the output center 136.

The frame link 14, lower arm 20, upper arm 18 and toggle link 16 when connected may have a trapezoidal configuration, which is illustrated in FIG. 4. The rotateable connection therebetween provides for rotational movement of the toggle link 16, upper arm 18 and lower arm 20 about the inertial reference frame of the frame link 14. Accordingly, when the vehicle wheel 22 is driven over a bump, the wheel 22 and associated toggle link 16 may be displaced vertically as the toggle link 16 rotates about the inertial reference frame of the frame link 14.

The shock absorbing nature of the suspension system 12 may be provided by a shock-absorbing element 62 which may be rotateably connected to the upper arm 18 (see FIG. 4). By way of example and not limitation, the shock-absorbing element 62 may be an adjustable or fixed compression spring, or gas charged shock. The second frame link pivot point 50 may be interposed between the connection points of the upper arm 18 and the second toggle link pivot point 38 and the shock-absorbing element 62. In this way, as the upper arm 18, lower arm 20 and the toggle link 16 rotate about the frame link 14, the shock-absorbing element 62 provides shock absorption in response to bumps along the vehicle travel path.

As more particularly shown in FIGS. 2-4, the four bar linkage suspension system 12 provides a suspension system to the bicycle 10 by allowing vertical displacement of the rear wheel 22 as the rear wheel 22 rides over a bump on a travel path of the bicycle while maintaining a constant distance “X” between the wheel axis 40 and the output center 36 throughout the vertical displacement. In this regard, as stated above, chain tensioners and chain guides are not required to maintain the chain on the output 34 (i.e., transmission cog) and the wheel input 26 (i.e., wheel sprocket).

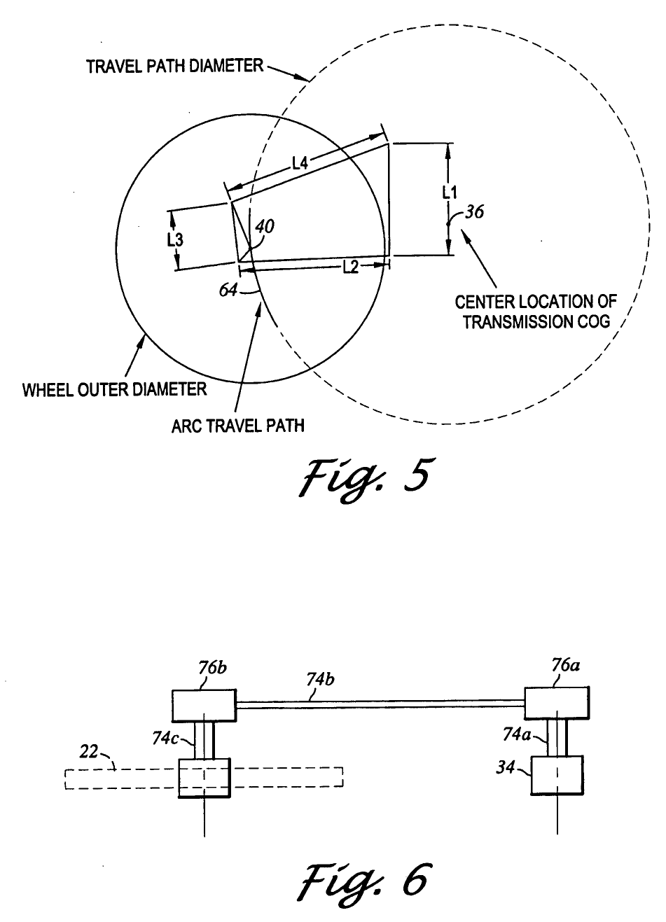

More particularly, FIG. 2 illustrates the four bar linkage suspension system 12 in a pre impact position. As shown, the distance between the wheel axis 40 and the output center 36 is “X.” FIGS. 3 and 4 illustrate the four bar linkage suspension system 12 in a post impact position. FIG. 4 illustrates the fully extended post impact position, and FIG. 3 illustrates the suspension system as it approaches the fully extended post impact position or its return to the pre-impact position from the fully extended post impact position. However, in all three positions, the distance between the wheel axis 40 and the output center 36 is maintained at “X” length (i.e., constant radius). Accordingly, tensioners, chain guides and the like are not required to maintain the chain on the wheel input 26 and the output 34. In other words, referring now to FIG. 5, the travel path 64 of the wheel axis as the system 12 traverses between the pre-impact position and the fully extended post impact position has a constant radius about the output center 36 in that chain guides, chain tensioners and the like are not required to maintain the chain on the wheel input 26 and the output 34. As used herein, the term “constant radius” refers to a distance between the wheel axis and the output center, which may increase or decrease but remains within a range such that the mode of transmitting power (i.e., belt, chain or shaft) from the output to the wheel input (i.e., wheel sprocket) does not require extra parts.

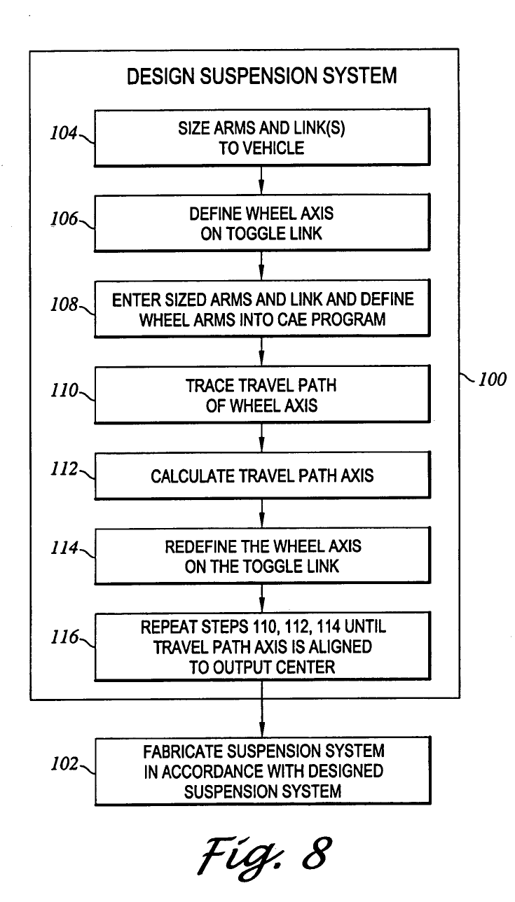

In another aspect of the present invention, referring now to FIG. 8, the method of designing a multi-bar linkage suspension system 12 may comprise the steps of designing the suspension system 100 and fabricating the suspension system 102 in accordance with the designed suspension system.

The designing step 100 may be accomplished with the aid of a computer. In particular, the designing step 100 may include the step of sizing 104 the lower arm 20, upper arm 18, toggle link 16 and frame link 14 with respect to the vehicle 10 which will incorporate the suspension system 12. In other words, the toggle link length 42, frame link length 52, the distance between the first toggle link and frame link pivot points 37, 48, and the distance between the second toggle link and frame link pivot points 38, 50 are defined. In this way, the size of the lower arm 20, upper arm 18, toggle link 16 and frame link 14 may be appropriate to provide an appropriate amount of shock absorption to the vehicle 10 in response to bumps along the vehicle travel path. Furthermore, the wheel axis 40 may be positioned on and defined by the toggle link 16, which is represented as step 106 on FIG. 8. The distance between the wheel axis 40 and the first toggle link pivot point 37 may define a first leg length 66, and the distance between the wheel axis 40 and the second toggle link pivot point 38 may define a second leg length 68.

Once the sizes of the lower arm 20, upper arm 18, toggle link 16 and the frame link 14 have been determined, the same may be entered (i.e., step 108 as shown on FIG. 8) into a computer aided drafting program or a computer aided engineering (CAE) program to aid in the rotational simulation of the lower arm 20, upper arm 18, toggle link 16 and frame link 14 to each other. Thereafter, the lower arm 20, upper arm 18, toggle link 16 and frame link 14 may be assembled in the computer aided engineering program as discussed above. The computer aided engineering program may then simulate rotational movement of the lower arm 20, upper arm 18 and toggle link 16 within the inertial reference frame of the frame link 14 between a pre-impact position (see FIG. 2) and a fully extended post-impact position (see FIG. 4). As the system 12 is traversed between the pre-impact position and the fully extended post-impact position, the wheel axis travel path 64 may be traced (i.e., tracing step 110, as shown in FIG. 8), as shown in FIG. 5. This traced travel path 64 will be an arc having a constant radius about its axis 70.

The travel path axis 70 is then calculated (i.e., calculating step 112, as shown in FIG. 8) with three points from the traced wheel axis travel path 64. The output center 36 should be aligned with the wheel axis travel path axis 70. However, if the travel path axis 70 is not aligned with the output center 36, then the wheel axis 40 may be repositioned on and redefined by the toggle link 16 until the travel path axis 70 is aligned to the output center 36. These steps are illustrated as the redefining step 114 and the repeating step 116 shown in FIG. 8. The repositioning of the wheel axis 40 may be accomplished by altering the relationship between the first and second leg lengths 66, 68 to move the wheel axis 40 closer or further away from the toggle link line 44 or closer or further away from the first and second toggle link pivot points 37, 38. Further, as will be discussed below, the ratio of the second leg length 66 to the first leg length 68 should be maintained between about 1.2 and about 3.7.

The suspension system 12 discussed above provides advantages over prior art suspension systems. In particular, the wheel 22 (in this example, the rear wheel) may be vertically displaced (i.e., pre-impact position to fully extended post-impact position) while the distance between the wheel axis 40 and output center 36 remains constant through the vertical displacement. In this regard, chain guides, chain tensioners and the like are not required to maintain the chain on the wheel input 26 and the output 34 because vertical displacement of the rear wheel 22 does not increase slack in the chain connecting the wheel input 26 and power transmission system output 34. Accordingly, this allows for a greater range in shock arc travel path and performance design, and an increase in spring force dampening coefficients selectivity range to reach a desired suspension dynamic response.

Further, another advantage of the suspension system 12 over the prior art suspension systems is that the power transmission system 28 may include a gear shifting mechanism 72 (see FIG. 1) that may be attached to or made integral with the frame link 14 and aligned to the output center 36. Accordingly, this allows for improved and strengthened wheel components. In use, the power produced from the pedals 30 may be transmitted to the transmission cog 34 via the gear shifting mechanism 72. Hence, this arrangement of the gear shifting mechanism may eliminate the need for a derailleur to shift between rear wheel sprockets. The gear shifting mechanism may be a SPEEDHUB sold by ROHLOFF AG.

Moreover, power transmission between the output 34 and the wheel input 26 may be accomplished via other methods. In FIGS. 2-4, the power transmission was accomplished with a chain. However, the power transmission therebetween may be accomplished with a belt or shaft. For example, referring now to FIG. 6, the output 34 may provide rotational power to the rear wheel 22 via a series of shafts 74. The output shaft 74a connected to the output 34 may be attached to a gear box 76a, which provides rotation to a transverse shaft 74b. The transverse shaft 74b may transmit rotational power to another gear box 76b adjacent the rear wheel 22, which attaches a wheel shaft 74c and provides rotational power to the rear wheel 22.

Table 1 provides five differently sized arms 18, 20, links 14, 16 and wheel axis 40 defined by first and second leg lengths 66, 68. In this regard, Table 1 provides preferably ranges for the second leg length to first leg length ratio and minimum/maximum lengths for the frame link length 52, toggle link length 42, lower arm length 58 and upper arm length 60. In particular, the second leg length to first leg length ratio may be between about 1.2 to about 3.7. The minimum and maximum length for the frame link length 52 may be between about 10.44 inches to about 16 inches. The minimum and maximum length for the toggle link length 42 may be between about 4.25 inches to about 8 inches. The minimum and maximum length for the lower arm length 58 may be between about 15.1 inches to about 23 inches. The minimum and maximum length for the upper arm length 60 may be between about 15 inches to about 22 inches. The minimum and maximum length for the first leg length 66 may be between about 1.5 inches to about 2.5 inches. The minimum and maximum length for the second leg length 68 may be between about 2.53 inches to about 6.25 inches.

TABLE 1

| | Frame Link | Toggle Link | Lower Arm | Upper Arm | First Leg | Second Leg |
|---|---|---|---|---|---|---|
| Example | Length (L1) | Length (L3) | Length (L2) | Length (L4) | Length (66) | Length (68) |
| Number | (inches) | (inches) | (inches) | (inches) | (inches) | (inches) |
| 1 | 10.44 | 4.25 | 15.82 | 15 | 2 | 2.53 |
| 2 | 11.5 | 6.75 | 16 | 17 | 1.5 | 5.5 |
| 3 | 12.5 | 6.95 | 19.2 | 17.95 | 1.75 | 5.75 |
| 4 | 16 | 8 | 23 | 22 | 2.5 | 6.25 |
| 5 | 11.56 | 6.25 | 15.1 | 16.92 | 1.72 | 5.22 |

This description of the various embodiments of the present invention is presented to illustrate the preferred embodiments of the present invention, and other inventive concepts may be otherwise variously embodied and employed. The appended claims are intended to be construed to include such variations except insofar as limited by the prior art.

What is claimed is:

1. A suspension system of a vehicle attachable to a vehicle frame for absorbing shocks caused by bumps along a vehicle travel path, the vehicle having a wheel defining a wheel rotation center, a power transmission system defining an output and its output center, and the vehicle frame defining first and second vehicle frame pivot points, the system comprises:
a lower arm rotateably connected to the vehicle frame at the first vehicle frame pivot point;
an upper arm rotateably connected to the vehicle frame at the second vehicle frame pivot point; and
a toggle link including:
a first toggle link pivot point, the lower arm being rotateably connected to the toggle link at the first toggle link pivot point;
a second toggle link pivot point, the upper arm being rotateably connected to the toggle link at the second toggle link pivot point, the first and second toggle link pivot points defining a toggle link line; and
a wheel axis for alignment with the wheel rotation center, the wheel axis being interposed between the toggle link line and the output center for rotating the wheel axis about the output center at a constant radius as the lower arm, upper arm and toggle link cooperatively rotate about respective pivot points and frame in response to the bumps along the vehicle travel path.

2. The suspension system of claim 1 wherein the first and second frame pivot points define a frame line, and the frame line is interposed between the output and the wheel axis.

3. The suspension system of claim 1 further comprising a shock-absorbing element attached to the upper arm and the frame.

4. The suspension system of claim 1 wherein the first and second frame pivot points define a frame length, the first and second toggle link pivot points define a toggle link length, and the frame length to toggle link length ratio is greater than 1.

5. The suspension system of claim 4 wherein the frame length is between about 2.67 inches and about 33 inches, and the toggle link length is between about 1 inch and about 27 inches.

6. The suspension system of claim 1 wherein the distance between the frame and toggle link first pivot points is between about 4.17 inches and about 45 inches, and the distance between the frame and toggle link second pivot points is between about 4.17 inches and about 45 inches.

7. The suspension system of claim 1 wherein a first leg length is defined between first toggle link pivot point and wheel axis, and a second leg length is defined between the second toggle link pivot point and the wheel axis, and the second leg length to first leg length ratio is greater than 1.

8. The suspension system of claim 7 wherein the second leg length to first leg length ratio is between about 1.2 to about 3.7.

9. A vehicle comprising:
a power transmission system having an output defining an output center;
a wheel defining a wheel center;
a frame defining first and second frame pivot points;
a suspension system for absorbing shocks caused by bumps along a vehicle travel path, the suspension system having:
a lower arm rotateably connected to the vehicle frame at the first frame pivot point;
an upper arm rotateably connected to the vehicle frame at the second frame pivot point;
a toggle link including:
a first toggle link pivot point, the lower arm being rotateably connected to the toggle link at the first toggle link pivot point;
a second toggle link pivot point, the upper arm being rotateably connected to the toggle link at the second toggle link pivot point, the first and second toggle link pivot points defining a toggle link line;
a wheel axis aligned to the wheel rotation center with the wheel rotateably connected to the toggle link, the wheel axis being interposed between the toggle link line and the output center for rotating the wheel axis about the output center at a constant radius as the lower arm, upper arm and toggle link cooperatively rotate about respective pivot points and frame in response to bumps along the vehicle travel path.

10. The vehicle of claim 9 wherein the first and second frame pivot points define a frame line, and the frame line is interposed between the output and the wheel axis.

11. The vehicle of claim 9 further comprising a shock absorbing element attached to the upper arm and the frame.

12. The vehicle of claim 9 wherein the first and second frame pivot points define a frame length, the first and second toggle link pivot points define a toggle link length, and the frame length to toggle link length ratio is greater than 1.

13. The vehicle of 9 wherein a first leg length is defined between first toggle link pivot point and the wheel axis, a second leg length is defined between the second toggle link pivot point and the wheel axis, and the second leg length to first leg length ratio is greater than 1.

14. A method of fabricating a suspension system of a vehicle attachable to a vehicle frame which absorbs shocks caused by bumps along a vehicle travel path, the vehicle having a wheel defining a wheel rotation center, a power transmission system defining an output and its output center, and the vehicle frame defining first and second frame pivot points, the method comprising the steps of:
designing the suspension system comprising the steps of:
sizing an upper arm, lower arm and toggle link to the vehicle;
connecting the lower and upper arms to the toggle link at first and second toggle link pivot points, respectively;
connecting the lower and upper arms to the vehicle frame at the first and second frame pivot points; and
defining a wheel axis for alignment with the wheel rotation center between a toggle link line and the output; and
fabricating the suspension system in accordance with the designed suspension system.

15. The method of claim 14 wherein the designing step further comprises the steps of:
rotating the lower arm, upper arm and toggle link about respective pivot points and frame;
tracing a travel path of the wheel axis about the output as the upper arm, lower arm and toggle link cooperatively rotate about respective pivot points;
calculating a travel path axis based on the traced travel path;
redefining the wheel axis relative to the first and second toggle link pivot points until the travel path axis is aligned to the output center.

16. The method of claim 15 where in the calculating steps includes the step of determining the travel path axis based on multiple points along the traced travel path.

17. The method of claim 14 wherein the connecting steps include the step of inputting the sized upper arm, lower arm and toggle link into a computer aided engineering program to assist in simulating rotational movement of the upper arm, lower arm and toggle link about respective pivot points.
